(19) United States
(12) Patent Application Publication
(10) Pub. No.: US 2002/0128917 A1
(43) Pub. Date: Sep. 12, 2002

(54) Method and apparatus for processing financial transactions

(75) Inventor: Gavin A. Grounds, Plano, TX (US)

Correspondence Address: William R. Borchers, Baker Botts L.L.P., Suite 600, 2001 Ross Avenue, Dallas, TX, 75201-2980, US

(73) Assignee: Electronic Data Systems Corporation

(21) Appl. No.: 09/800,535

(22) Filed: Mar. 6, 2001

(51) Int. Cl. G06F 17/60

(52) U.S. Cl. 705/26

(57) ABSTRACT

An apparatus and method for processing financial transactions include the capability to receive a first message indicating the making of a financial transaction, the message containing customer information and transaction information. The apparatus and method also include the capability to determine the validity of the customer information and to generate a second message indicating non-authorization of the financial transaction if the customer information is invalid. The apparatus and method additionally include the capability to determine whether the financial transaction involves a micro-payment if the customer information is valid and, if the financial transaction involves a micro-payment, store at least part of the transaction information and generate a third message indicating authorization of the financial transaction. The apparatus and method further include the capability to generate an authorization request if the financial transaction does not involve a micro-payment.

### BACKGROUND OF THE INVENTION

Typical systems for processing a financial transaction involving a customer using a third-party account, such as a credit card, to pay for goods and/or services require numerous exchanges of information between a variety of financial components. These exchanges protect the merchant by, for example, verifying that the customer's account is in good standing and that the customer has the ability to pay for the goods and/or services.

Unfortunately, these exchanges of information can cause problems. For example, the exchanges may cause a delay in completing the sale of the goods and/or services between the merchant and the customer, which may frustrate the merchant and the customer. As another example, the exchanges may generate an increased cost to the merchant in completing the sale, which is usually passed on to the customer. As a further example, for relatively inexpensive goods and/or services, the increased cost of the sale due to the processing of the financial transaction may completely eliminate the use of third-party accounts to purchase these types of items. This would cause a severe handicap for merchants who deal mainly in these types of items, not to mention the customers who desire these types of items and do not want to or do not have the ability to pay with cash.

Accordingly, reducing the number of exchanges of information required to complete a financial transaction should alleviate at least some of these problems. In reducing the number of exchanges of information, however, the merchant may have increased monetary liability for financial transactions that involve invalid accounts, such as stolen credit cards. Thus, to ensure an economically viable system for processing financial transactions by using a reduced number of exchanges of information, some form of protection must be included for the merchant.

### SUMMARY OF THE INVENTION

The present invention substantially reduces or eliminates at least some of the disadvantages and problems associated with previously developed systems for processing financial transactions. Accordingly, in certain embodiments, the present invention provides a method and apparatus that utilize a decreased number of exchanges of information in authorizing certain financial transactions while at the same time providing protection for merchants from invalid financial transactions.

In particular embodiments, an apparatus for processing financial transactions, includes a memory and a processor coupled to the memory. The memory is operable to store information and a program. The memory is also operable to store a first message indicating the making of a financial transaction, the first message including customer information and transaction information. The processor is operable to determine the validity of the customer information and to generate a second message indicating non-authorization of the financial transaction if the customer information is invalid. The processor is also operable to determine whether the financial transaction involves a micro-payment if the customer information is valid and to instruct the memory to store at least part of the transaction information and generate a third message indicating authorization of the financial transaction if the financial transaction involves a micro-payment. The processor is further operable to generate an authorization request if the financial transaction does not involve a micro-payment.

In some embodiments, a method for processing financial transactions includes receiving a first message indicating the making of a financial transaction, the first message including customer information and transaction information. The method also includes determining the validity of the customer information and generating a second message indicating non-authorization of the financial transaction if the customer information is invalid. The method additionally includes determining whether the financial transaction involves a micro-payment if the customer information is valid. The method further includes storing at least part of the transaction information and generating a third message indicating authorization of the financial transaction if the financial transaction involves a micro-payment and generating an authorization request if the financial transaction does not involve a micro-payment.

The present invention has several technical features and advantages. For example, in particular embodiments, the invention allows at least some financial transactions to be authorized in a shorter amount of time, which reduces anxiety of customers and merchants. As another example, in certain embodiments, the invention allows at least some financial transactions to be authorized at a reduced cost, which reduces the cost of sales to merchants, and hopefully customers, and may allow new areas of commerce to emerge. As a further example, in some embodiments, the invention provides increased protection to merchants using financial transactions. As an additional example, in particular embodiments, the invention allows the financial transactions to be available over a widely dispersed geographic area. Other embodiments may possess none, one, some, or all of these technical features and advantages and/or additional technical features and advantages.

Other technical features and advantages will be readily apparent to one of skill in the art from the following figures, description, and claims.

### BRIEF DESCRIPTION OF THE DRAWINGS

To provide a more complete understanding of the present invention, especially when considered in light of the following written description, and to further illuminate its technical features and advantages, reference is now made to the following drawings, in which:

FIG. 1 illustrates one embodiment of a system for processing financial transactions in accordance with the present invention;

FIG. 2 illustrates an embodiment of the system of FIG. 1 in which all of the components have computers;

FIG. 3 provides a detailed view of one embodiment of a transaction controller computer for the system of FIG. 1;

FIG. 4A illustrates one format for storing information regarding a micro-payment financial transaction in a buffer;

FIG. 4B illustrates one format for storing information regarding a non-micro-payment financial transaction in a buffer; and

FIG. 5 is a flowchart showing the operation of a transaction controller in accordance with the present invention.

### DETAILED DESCRIPTION OF THE INVENTION

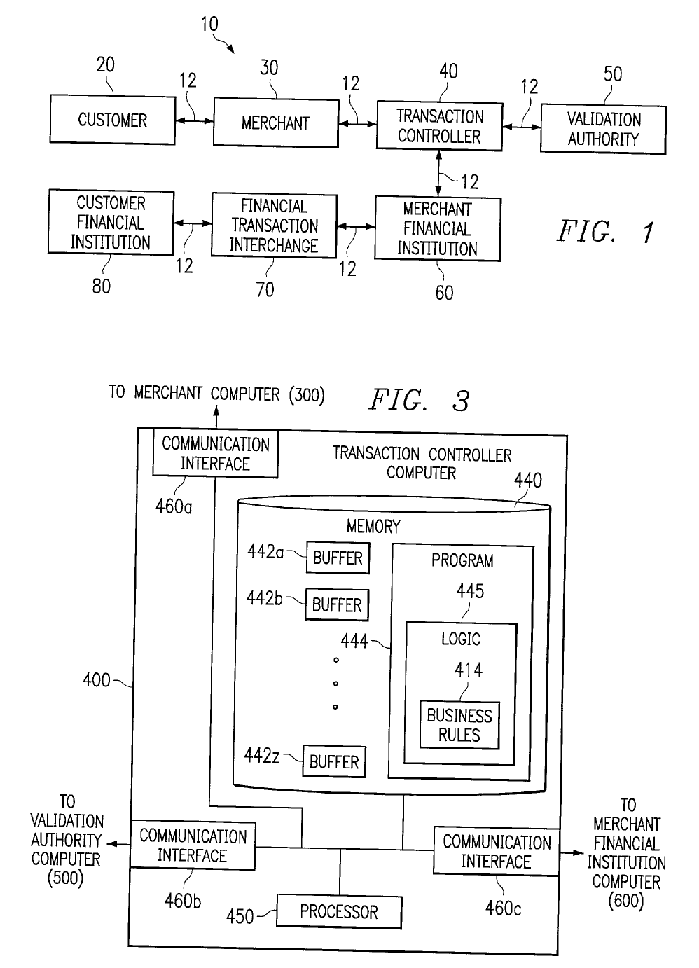

FIG. 1 illustrates one embodiment of a system 10 for processing financial transactions in accordance with the present invention. System 10 includes a customer 20, a merchant 30, a transaction controller 40, a validation authority 50, a merchant financial institution 60, a financial transaction interchange 70, and a customer financial institution 80, which comprise the components for a financial transaction in system 10. The components of system 10 may be humans, physical structures, and/or machines, such as computers, and exchange information with each other by communication links 12. Thus, communication links 12 may allow human-to-human exchanges of information, human-to-machine exchanges of information, and/or machine-to-machine exchanges of information. For communications that involve machine-to-machine exchanges of information, communication links 12 may be twisted pair wire, fiber optic cable, wireless transmission channels, and/or any other type of medium for exchanging information.

In operation, merchant 30 provides information regarding the goods and/or services that it has available to customer 20. Customer 20 then selects the desired goods and/or services. After determining that customer 20 has selected goods and/or services, merchant 30 informs customer 20 of the available payment options, such as cash, check, credit card, and/or debit card. Customer 20 then selects the desired payment option. If customer 20 selects a payment form other than cash, merchant 30 may have to validate the transaction information, such as, for example, the account identifier of the account being used to pay for the transaction and the amount of the purchase, before providing the goods and/or services to customer 20. To validate the transaction information, merchant 30 sends a financial transaction request, which would include at least part of the transaction information, such as the account identifier and the amount of the financial transaction, to transaction controller 40. Once transaction controller 40 receives the financial transaction request, transaction controller 40 forwards part of the information in the financial transaction request, such as the account identifier, to validation authority 50 as a validation request.

Validation authority 50 then determines whether customer 20 is valid. For example, validation authority 50 may examine the account identifier to determine whether it is associated with an account that is in good standing and/or may determine whether customer 20 is an authorized user of the account. After determining the validity of customer 20, validation authority 50 sends a validation response to transaction controller 40.

After receiving the validation response, transaction controller 40 examines the validation response to determine whether customer 20 is valid. If customer 20 is invalid, transaction controller 40 generates an authorization message indicating that the financial transaction is not authorized and sends the message to merchant 30. If, however, customer 20 is valid, transaction controller 40 performs further operations.

Upon determining that customer 20 is valid, transaction controller 40 determines whether the financial transaction requested involves a “micro-payment”. A micro-payment may be an amount that merchant 30 and merchant financial institution 60 have previously agreed will not require authorization for merchant 30 to be protected if the financial transaction is invalid, perhaps due to the account identifier being associated with a stolen credit card. Accordingly, if the financial transaction involves a micro-payment, transaction controller 40 generates an authorization message indicating that the financial transaction is authorized and sends the message to merchant 30, who then provides the goods and/or services to customer 20. Transaction controller 40 additionally stores at least part of the transaction information, such as, for example, the account identifier, the time the financial transaction was initiated, and the amount of the financial transaction, for later settlement. If, however, the financial transaction does not involve a micro-payment, transaction controller 40 generates an authorization request and sends it to merchant financial institution 60. The authorization request includes information regarding the financial transaction, such as, for example, the account identifier and the amount of the financial transaction.

After receiving the authorization request, merchant financial institution 60 determines whether the account identifier is associated with an account serviced by merchant financial institution 60. If the account identifier is associated with an account serviced by merchant financial institution 60, merchant financial institution 60 determines whether to authorize the financial transaction based on the current status of the account, such as, for example, the amount of credit and/or funds in the account. Merchant financial institution 60 would then, based on the result of the determination, generate and send an appropriate authorization response to transaction controller 40. On the other hand, if the account identifier is not associated with an account serviced by merchant financial institution 60, merchant financial institution 60 forwards the authorization request to financial transaction interchange 70.

Upon receiving an authorization request from merchant financial institution 60, financial transaction interchange 70 determines a financial institution that is associated with the account identifier. Financial transaction interchange 70 then forwards the authorization request to the appropriate financial institution—customer financial institution 80 in the illustrated embodiment.

Following the receipt of the authorization request, customer financial institution 80 determines whether to authorize the financial transaction based on the status of the account associated with the account identifier, such as, for example, the amount of credit available and/or the funds in the account. Based on the result of the determination, customer financial institution 80 would generate and send an appropriate authorization response to transaction controller 40.

Upon receiving the authorization response, generated by either merchant financial institution 60 or customer financial institution 80, transaction controller 40 examines the authorization response to determine whether the financial transaction is authorized. If the financial transaction is authorized, transaction controller 40 stores at least part of the transaction information for later settlement and generates and sends an authorization message indicating that the financial transaction is authorized to merchant 30. If, however, the examination reveals that the financial transaction is not authorized, transaction controller 40 generates and sends an authorization message indicating that the financial transaction is not authorized to merchant 30.

After receiving an authorization response from transaction controller 40, merchant 30 examines the authorization response to determine whether the financial transaction is authorized. If the financial transaction is authorized, merchant 30 provides the goods and/or services to customer 20. If, however, the financial transaction is not authorized, merchant 30 decides whether to provide goods and/or services to customer 20.

In general, whether a financial transaction involves a micro-payment could be based on a variety of factors, such as, for example, the amount of the financial transaction, the frequency of such transactions, and/or the identity of customer 20. The rules for determining whether a financial transaction involves a micro-payment may be established between merchant 30 and merchant financial institution 60 and then implemented by transaction controller 40. The rules may be expressed in a Merchant Agreement or any other appropriate type of agreement. In a particular embodiment, a micro-payment is defined only in terms of the amount of the financial transaction; thus, if the amount of the financial transaction is below a certain threshold, for example, five dollars, the financial transaction involves a micro-payment. Note, each merchant that is serviced by transaction controller 40 may have a different set of rules for determining whether a financial transaction involves a micro-payment because the agreement between each merchant and their particular financial institution may differ.

As described in this embodiment, the present invention has several technical features and advantages. For example, by allowing at least some financial transactions to be authorized after relatively few exchanges of information, system 10 allows these financial transactions to be authorized in a shorter amount of time, which may be psychologically and financially beneficial to customers and merchants. As another example, by allowing these financial transactions to be authorized after relatively few exchanges of information, system 10 allows these financial transactions to be authorized relatively inexpensively, which should reduce the cost merchants incur in providing goods and/or services and may allow new areas of commerce to emerge, especially in the sale or license of digital media, such as songs and/or videos. As a further example, because system 10 allows credit and/or debit cards to be used as the payment mechanism, the invention is available over a widely dispersed geographic area, allowing for greater customer flexibility.

Additionally, at least certain embodiments of the invention have the advantage of being able to be implemented using agreements that are already recognized and supported by regulatory and legal frameworks around the world. For example, the Merchant Agreement may contain rules and agreements pertaining to what qualifies as a micro-payment, how these transactions are to be handled, when they are to be settled, and any other appropriate rule, as well as provide assurances to the merchant that as long certain criteria are complied with, the financial transaction will be honored and settled. Similarly, the risk of invalid transactions may be spread through the effective use of the “Card Holder Agreement” or “Credit Agreement” between the issuing institution and the consumer. For example, the terms and conditions surrounding any indemnities for the use of systems and mechanisms implementing portions of the present invention may be defined and agreed upon. Being able to use these well understood agreements to implement these embodiments will allow their ready acceptance and, hence, use over wide geographic regions, and potentially the world.

As mentioned previously, the components of system 10 may have a variety of forms. For example, customer 20 may be a human or a machine under the control of a human, such as a personal computer, a cellular telephone, a personal digital assistant, and/or any other type of device that allows a human to exchange information with another machine and/or human. Merchant 30, in turn, may be a traditional store, a catalog retailer, an Internet retailer, and/or any other type of provider of goods and/or services. Thus, for example, if merchant 30 is an Internet retailer, customer 20 is likely a human operating a machine that can communicate with a web server of merchant 30. On the other hand, if merchant 30 is traditional store, customer 20 is likely a human that is in the store of merchant 30. Similarly, transaction controller 40, validation authority 50, merchant financial institution 60, financial transaction interchange 70, and customer financial institution 80 may be physical locations, such as, for example, an office, or machines, such as, for example, a computer, a router, a server, and/or a web server. In particular embodiments, transaction controller 40 is a payment gateway, such as, for example, the payment gateway operated by Bank One or Visa USA, validation authority 50 is a Certificate Authority, such as, for example, VeriSign, Inc., Entrust.net Ltd., XCert International, Inc., or any other privately-labeled or closed community Certificate Authority, financial transaction interchange 70 is an interchange system, such as, for example, the one operated by First Data Resources, and merchant financial institution 60 and customer financial institution 80 are any institutions that issue credit or financial accounts and/or settlement services, including banks, such as, for example, CitiBank, Barclays, and Chase. Furthermore, in certain embodiments, some of the components of system 10 may be a combination of physical locations and machines. For example, merchant financial institution 60 may have a physical location and also have machines that process financial transactions. As another example, merchant 30 may have a physical location, such as a store, that has machines that process financial transactions, such as point of sale credit card machines. A variety of other forms exist.

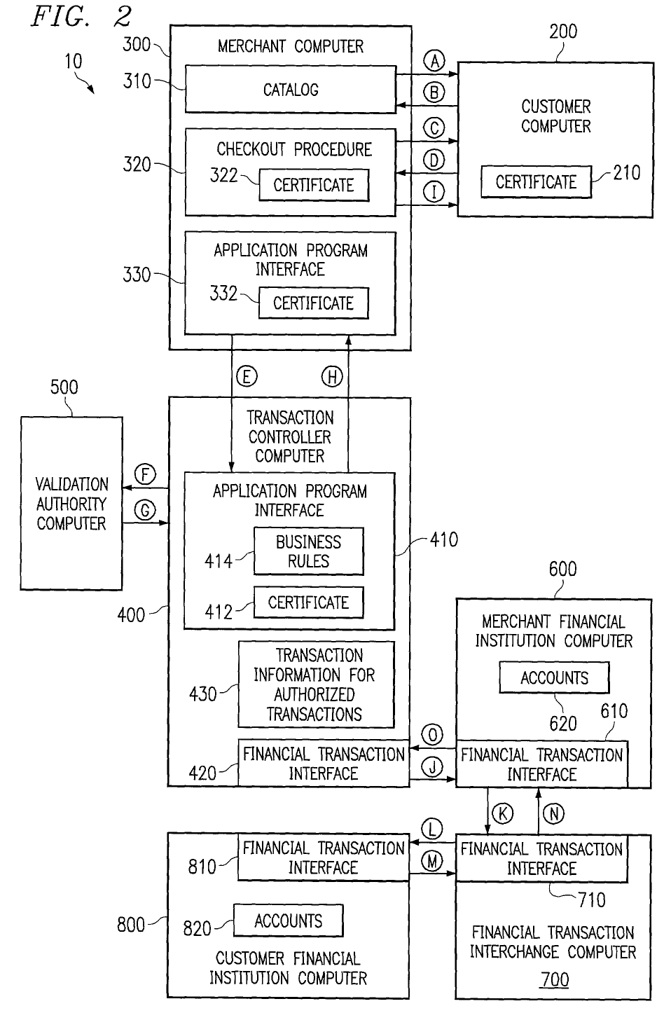

FIG. 2 illustrates an embodiment of system 10 in which all of the components either have or are computers. Thus, in this embodiment, system 10 includes a customer computer 200, a merchant computer 300, a transaction controller computer 400, a validation authority computer 500, a merchant financial institution computer 600, a financial transaction interchange computer 700, and a customer financial institution computer 800. These computers may be linked together by any type of wireless, optical, and/or wireline links and/or any type of communication networks, such as, a packet switched network, a frame relay network, a wave division multiplexing (WDM) network, and/or any other type of network for transferring information from one point to another point. Because all of the components of system 10 have computers in this embodiment, this embodiment of system 10 is likely to be useful in facilitating transactions that occur between merchant 30 and customer 20 over a communication network, such as, for example, the Internet. Note that the computers are illustrated mainly in terms of their operations in FIG. 2 rather than in terms of their configuration.

In operation, merchant computer 300, using a catalog 310, provides information regarding the goods and/or services of merchant 30 to customer computer 200 as communication A. Customer computer 200, probably under the control of a human, then selects the goods and/or services desired and communicates this selection to merchant computer 300 as communication B. After receiving communication B from customer computer 200, merchant computer 300 initiates a checkout procedure 320. During checkout procedure 320, merchant computer 300 sends a list of available payment options, which typically includes a list of credit and/or debit card options, to customer computer 200 as communication C. Upon receiving communication C from merchant computer 300, customer computer 200, again probably under the control of a human, selects the payment option desired. After selecting the desired payment option, customer computer 200 sends information for the selected payment option, which typically includes a name, an account identifier, and an expiration date, along with customer information, which includes a certificate 210 identifying customer 20, to merchant computer 300 as communication D. Certificate 210 may be a digital certificate, such as is employed in Public Key Infrastructure (PKI), or a digital file or packet that represents an authenticated electronic message or instruction from customer computer 200. The file or packet may be encrypted or digitally signed using “keys” employed in a PKI environment. In a particular embodiment, certificate 210 complies with a present or future version of X.509.

Upon receiving communication D, merchant computer 300 generates a financial transaction request by using application program interface (API) 330, which is responsible for exchanging information with transaction controller computer 400. The financial transaction request includes: 1) transaction information, such as, for example, the time the financial transaction was initiated, the amount of the financial transaction, and the account identifier of the customer; 2) customer information, such as certificate 210; and 3) merchant information, such as, for example, a certificate 322, which identifies merchant 30, and a certificate 332, which identifies API 330. The financial transaction request is sent to transaction controller computer 400 as communication E.

Following receipt of communication E from merchant computer 300, transaction controller computer 400 processes the financial transaction request using an application program interface 410. Using API 410, transaction controller computer 400 generates a validation request, based on certificate 210 from customer computer 200 and certificate 322 and certificate 332 from merchant computer 300, in order to validate customer 20 and merchant 30. Note, this validation request also includes a certificate 412 so that API 410 may be validated. The validation request is sent to validation authority computer 500.

After receiving the validation request, validation authority computer 500, which could be a Certificate Authority using public key infrastructure (PKI), for example, determines the items involved in making the request, API 330 and API 410, are valid. Then, validation authority computer 500 determines whether customer 20 and merchant 30 are valid. To make these determinations, validation authority computer 500 would examine the certificates, possibly after decrypting them, to determine whether they have been tampered with and the party to which each belongs. Once determining the party to which each belongs, validation authority computer 500 may determine whether the parties are valid. Note, in a particular embodiment, a digital signature, or multiple digital signatures, which may have been validated using mechanisms such as a password or a biometric authentication, may accompany certificate 210 to provide further validation of customer 20 to validation authority computer 500. If the certificates have not been tampered with, and if the certificates belong to valid parties, validation authority computer 500 will probably determine that the parties are valid. Upon determining the validity status of the parties, validation authority computer 500 generates and sends a validation response to transaction controller computer 400 as communication G.

Upon receiving communication G, transaction controller computer 400 examines the validation response to determine whether both customer 20 and merchant 30 are valid. If either customer 20 or merchant 30 is invalid, transaction controller computer 400 generates and sends an authorization message as communication H to merchant computer 300 indicating that the financial transaction is not authorized. If, however, transaction controller computer 400 determines that both customer 20 and merchant 30 are valid, it applies a set of business rules 414 to the transaction information in the financial transaction request.

By applying business rules 414 to the transaction information, transaction controller computer 400 determines whether the financial transaction involves a micro-payment, which is a payment that merchant 30 and merchant financial institution 60 have agreed does not require authorization by the customer's financial institution for the merchant to be protected. In making this determination, business rules 414 may include examining the amount of the financial transaction, the identity of customer 20 for the financial transaction, the frequency of the type of financial transaction, and/or any other type of business rule related to classifying financial transactions upon which merchant 30 and merchant financial institution 60 agree. If transaction controller computer 400 determines that the financial transaction involves a micro-payment, it stores part of the transaction information, such as the time the financial transaction was initiated, the amount of the financial transaction, and the account identifier, at block 430 and generates and sends an authorization message indicating that the financial transaction is authorized to merchant computer 300 as communication H. If, however, transaction controller computer 400 determines that the financial transaction does not involve a micro-payment, it generates and sends an authorization request as communication J to merchant financial institution computer 600 through a financial transaction interface 420, such as, for example, a credit and/or debit card interface. The authorization request would include part of the transaction information, such as the account identifier and the amount of the financial transaction.

Merchant financial institution computer 600 receives communication J through a financial transaction interface 610, which is responsible for sending and receiving information regarding credit and/or debit card transactions for merchant financial institution computer 600. Upon receiving the authorization request, merchant financial institution computer 600 determines whether the account identifier is associated with one of accounts 620 serviced by merchant financial institution 60. If the account identifier is associated with one of accounts 620, merchant financial institution computer 600 determines whether to authorize the financial transaction. Merchant financial institution computer 600 may make this determination based upon a variety of factors, such as, for example, the amount of credit available in the associated account 620, the amount of funds available in the associated account 620, and/or any other appropriate type of financial factor. After determining whether to authorize the financial transaction, merchant financial institution computer 600 reserves an amount equivalent to the amount of the financial transaction in the associated account 620 and generates and sends an authorization response, including an authorization code, to transaction controller computer 400 through financial transaction interface 610 as communication O. If, however, merchant financial institution computer 600 determines that the account identifier is not associated with one of accounts 620, merchant financial institution computer 600 sends the authorization request to financial transaction interchange computer 700 as communication K.

Financial transaction interchange computer 700 receives communication K using a financial transaction interface 710, which is responsible for sending and receiving information regarding credit and/or debit card transactions for financial transaction interchange computer 700. After receiving communication K, financial transaction interchange computer 700 determines the financial institution associated with the account identifier—customer financial institution 80 in the illustrated in FIG. 1. Upon making this determination, financial transaction interchange computer 700 sends the authorization request to customer financial institution computer 800 through financial transaction interface 710 as communication L.

Upon receiving communication L through a financial transaction interface 810, which is responsible for sending and receiving information regarding credit and/or debit card transactions for customer financial institution computer 800, customer financial institution computer 800 determines which of accounts 820 is associated with the authorization request. After associating the authorization request with one of accounts 820, customer financial institution computer 800 determines whether to authorize the financial transaction. In making this determination, customer financial institution computer 800 may consider a variety of factors, such as, for example, the amount of credit available for the associated account 820, the amount of funds in the associated account 820, and/or a variety of other appropriate financial factors. If customer financial institution computer 800 determines that the financial transaction is authorized, customer financial institution computer 800 reserves an amount equivalent to the amount of the financial transaction in the associated account 820 and generates and sends an authorization response, including an authorization code, using financial transaction interface 810 as communication M. If, however, customer financial institution computer 800 determines that the financial transaction is not authorized, customer financial institution computer 800 generates and sends an authorization response indicating that the financial transaction is not authorized as communication M.

After receiving communication M, financial transaction interchange computer 700 forwards the authorization response to merchant financial institution computer 600 using financial transaction interface 710 as communication N. Merchant financial institution computer 600, in turn, forwards the authorization response to transaction controller computer 400 as communication O.

Following the receipt of communication O, which, as discussed, could have been generated by merchant financial institution computer 600 or customer financial institution computer 800, through financial transaction interface 420, transaction controller computer 400 examines the authorization response to determine whether the financial transaction is authorized. If the financial transaction is authorized, transaction controller computer 400 stores part of the transaction information, such as the time the financial transaction was initiated, the amount of the financial transaction, the account identifier, and the authorization code, at block 430. After this, transaction controller computer 400, in conjunction with API 410, sends an appropriate authorization message to merchant computer 300 as communication H.

Upon receiving communication H, merchant computer 300 examines the authorization message to determine whether the financial transaction is authorized. If the financial transaction is authorized, merchant computer 300 sends a transaction status message indicating that the purchase of the goods and/or services is complete to customer computer 200 as communication I and completes checkout procedure 320, which could include arranging for the delivery of the goods and/or services. If, however, the financial transaction is not authorized, merchant computer 300 generates and sends a transaction status message indicating that the purchase of the goods and/or services is not complete to customer computer 200 as communication I.

Assuming that the financial transaction is authorized, transaction controller computer 400, possibly at a later time, will, in accordance with business rules 414, generate a message to settle the financial transaction based on the transaction information in block 430. The business rules to generate this process could include the time, the number of financial transactions in block 430, the amount of the transactions in block 430, and/or any other suitable factor. The settlement message would convey the stored portion of the transaction information for the financial transaction, and any other financial transactions that have transaction information in block 430, to merchant financial institution computer 600.

As before, merchant financial institution computer 600 determines whether the account identifier for the financial transaction is associated with one of accounts 620. If the account identifier is associated with one of accounts 620, merchant financial institution computer 600 debits the associated account 620 and sends a credit to the account 620 associated with merchant 30. If, however, none of accounts 620 are associated with the account identifier, merchant financial institution computer 600 sends the settlement request to financial transaction interchange computer 700.

Upon receiving the settlement request, financial transaction interchange computer 700, as before, determines which financial institution is associated with the account identifier. After determining the financial institution associated with the account identifier, customer financial institution 80 in FIG. 1, financial transaction interchange computer 700 sends the settlement request to customer financial institution computer 800.

After receiving the settlement request, customer financial institution computer 800 debits the account 820 associated with the account identifier. The debiting of the account is controlled by the terms of an Account Holder Agreement or any other appropriate type of agreement between customer 20 and customer financial institution 80. Customer financial institution computer 800 also generates and sends a message to merchant financial institution computer 600 to credit the account 620 associated with merchant 30.

Although the computers in FIG. 2 have been discussed mainly in terms of their operations, it should be understood that these computers have hardware, such as, for example, memories, processors, and communication interfaces. The processors of the computers in FIG. 2 may be complex instruction set computers (CISCs), reduced instruction set computers (RISCs), or any other type of devices for manipulating information. The memories in the computers may be random access memories (RAMs), compact-disk read-only memories (CD-ROMs), erasable programmable read-only memories (EPROMs), or any other type of electromagnetic or optical volatile or non-volatile information storage devices. The communication interfaces for the computers may be modems, network interface cards, or any other type of devices for facilitating the exchange of information between computers. Furthermore, the computers in FIG. 2 may be interconnected, directly or indirectly, through communication networks, such as the Internet, a packet switched network, a frame relay network, or any other type of system for transferring information from one point to another point. Note, customer computer 200 may also have a communication interface for receiving input from a human, such as, for example, a serial port for a mouse or keyboard, and a device for displaying information, such as a monitor.

Additionally, the operations discussed for the computers in FIG. 2 may be implemented in a variety of fashions. For example, the operations in merchant computer 300—catalog 310, checkout procedure 320, and API 330—may be implemented in software and executed on a single processor. On the other hand, the operations of catalog 310, checkout procedure 320, and API 330 may be implemented on different sub-processors of merchant computer 300. Furthermore, the operations of catalog 310, checkout procedure 320, and API 330 may be implemented on processors at locations remote from each other. In addition, checkout procedure 320 could be provided to merchant 30 by an independent service provider. As another example, some of the operations of the computers in FIG. 2 may be combined into one computer. For example, merchant computer 300 may also have the operations of transaction controller computer 400, allowing merchant computer 300 to communicate directly with validation authority computer 500 and merchant financial institution computer 600. As another example, the operations of validation authority computer 500 may be incorporated into transaction controller computer 400. A variety of other implementations exist.

It should be understood that customer computer 200 and merchant computer 300 may not even be necessary. For example, if merchant 30 is a traditional store at which customer 20 is making a credit and/or debit card purchase, the operations of customer computer 200 and merchant computer 300 may not be necessary if transaction controller computer 400 is a point of sale credit card machine with the ability to read a credit and/or debit card, send validation requests, evaluate validation responses, send authorization requests, and evaluate authorization responses. The certificate of customer 20 may be stored electronically on a token, such as, for example, on a chip located on a card, on a magnetic strip, or on any other suitable storage media. The point of sale machine may also store transaction information for authorized transactions or send transaction information to be stored at a different location. A variety of other configurations exist.

The communications between the computers may be performed in a variety of manners. For example, a variety of protocols may be used to communicate between the computers, such as transmission control protocol/Internet protocol (TCP/IP), Ethernet, asynchronous transport mode (ATM), or any other suitable format for sending information between computers. In a specific embodiment, communications between customer computer 200 and merchant computer 300 are performed using TCP/IP, and communications between transaction controller computer 400, merchant financial institution computer 600, financial transaction interchange computer 700, and customer financial institution computer 800 are performed using ISO 8583. The communications between the computers in FIG. 2 may also be performed in a secure manner by using encryption schemes, such as, for example, RSA or SSL.

FIG. 3 provides a detailed view of one embodiment of transaction controller computer 400 for system 10. As illustrated, transaction controller computer 400 includes a memory 440, a processor 450, and three communication interfaces 460a-c. Memory 440 also includes several buffers 442a-z and a program 444 containing a set of logic 445. Buffers 442a-z store the transaction information for authorized financial transactions, two buffers being associated with each merchant handled by transaction controller computer 400. Memory 440, processor 450, and communication interfaces 460a-c may be interconnected using a bus.

In operation, communication interface 460a receives the financial transaction request from merchant computer 300. Upon detecting the receipt of the financial transaction request, processor 450, in accordance with program 444, generates a validation request based on the customer information and the merchant information and sends this request through communication interface 460b to validation authority computer 500. Upon receiving a validation response through communication interface 460b, processor 450 examines the validation response to determine whether both merchant 30 and customer 20 are valid. If either merchant 30 or customer 20 is not valid, processor 450 generates an authorization message indicating that the financial transaction is not authorized and sends this message through communication interface 460a to merchant computer 300.

If, however, both customer 20 and merchant 30 are valid, processor 450 determines whether the financial transaction involves a micro-payment using business rules 414, as discussed previously. If the financial transaction does involve a micro-payment, processor 450 determines that the transaction is authorized, stores part of the transaction information in buffer 442a, and generates and sends an authorization message indicating that the financial transaction is authorized through communication interface 460a. On the other hand, if processor 450 determines that the transaction does not involve a micro-payment, processor 450 generates an authorization request and sends the authorization request through communication interface 460c to merchant financial institution computer 600.

Upon receiving an authorization response through communication interface 460c, processor 450 examines the authorization response to determine whether the financial transaction is authorized. If the authorization response indicates that the financial transaction is authorized, processor 450 stores part of the transaction information in buffer 442b, generates an authorization message indicating that the financial transaction is authorized, and sends the authorization message through communication interface 460a. If, however, the financial transaction is not authorized, processor 450 generates and sends an authorization message indicating that the financial transaction is not authorized.

As discussed, buffers 442a-z are portions of memory 440 that store transaction information based on the merchant and type of financial transaction. For example, for merchant 30, buffer 442a stores transaction information for financial transactions that involve micro-payments, and buffer 442b stores transaction information for financial transactions that do not involve micro-payments. The transaction information stored in buffer 442a could include the time the financial transaction was initiated, the amount of the financial transaction, and the account identifier, and the transaction information stored in buffer 442b could include the same information plus the authorization code received in the authorization response. Buffers 442a-z may be physical locations in memory 440 or logical associations of memory 440, such as, for example, linked lists.

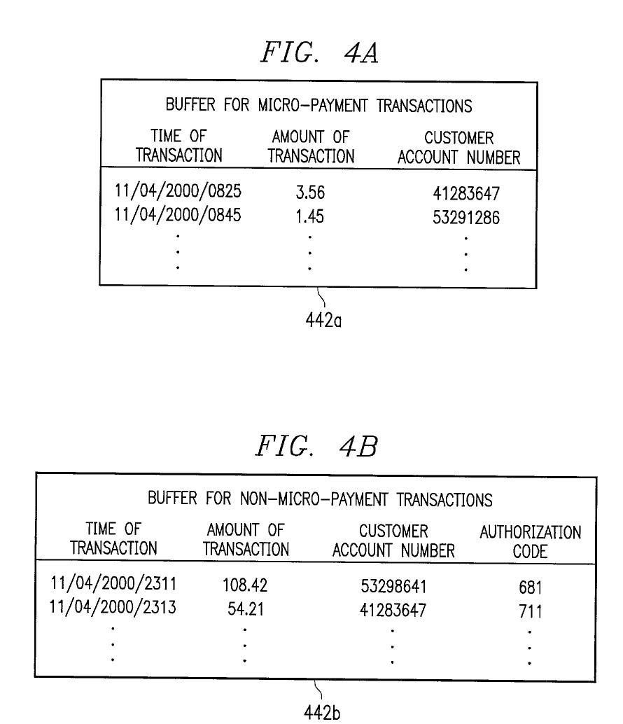

FIG. 4A and FIG. 4B illustrate one format for storing information in buffers 442a-b respectively. Buffer 442a stores transaction information for financial transactions that involve micro-payments. This transaction information includes the time the financial transaction was initiated, the amount of the financial transaction, and the account identifier of customer 20. The account identifier is an account number in the illustrated embodiment. Buffer 442b, on the other hand, stores transaction information for financial transactions that do not involve micro-payments. The transaction information in buffer 442b includes the time the financial transaction was initiated, the amount of the financial transaction, the account identifier of customer 20, and the authorization code received in the authorization response.

As mentioned previously, buffers 442a-b may accumulate transaction information for authorized financial transactions until a condition is met to settle all of the accumulated financial transactions for merchant 30. The financial transactions for merchant 30 may be settled upon the occurrence of a variety of conditions, such as, for example, the number of financial transactions, the amount of transactions, a time of day, and/or any other suitable condition. When such a condition is met, processor 450 generates a settlement message based on the transaction information in buffer 442a and/or the transaction information in buffer 442b and sends the settlement message to merchant financial institution computer 600.

Although one configuration for transaction controller computer 400 has been illustrated in FIG. 3, there are a variety of other different configurations for transaction controller computer 400. For example, communication interface 460a, communication interface 460b, and communication interface 460c may be combined to form a single communication interface for transaction controller computer 400. As another example, processor 450 may be broken down into a number of sub-processors that each handle a different operations for transaction controller computer 400. As a further example, memory 440 may be broken down into a variety of memories that store different parts of the information required by transaction controller computer 400. A variety of other different configurations and distributions of operations will be readily suggested to those skilled in the art.

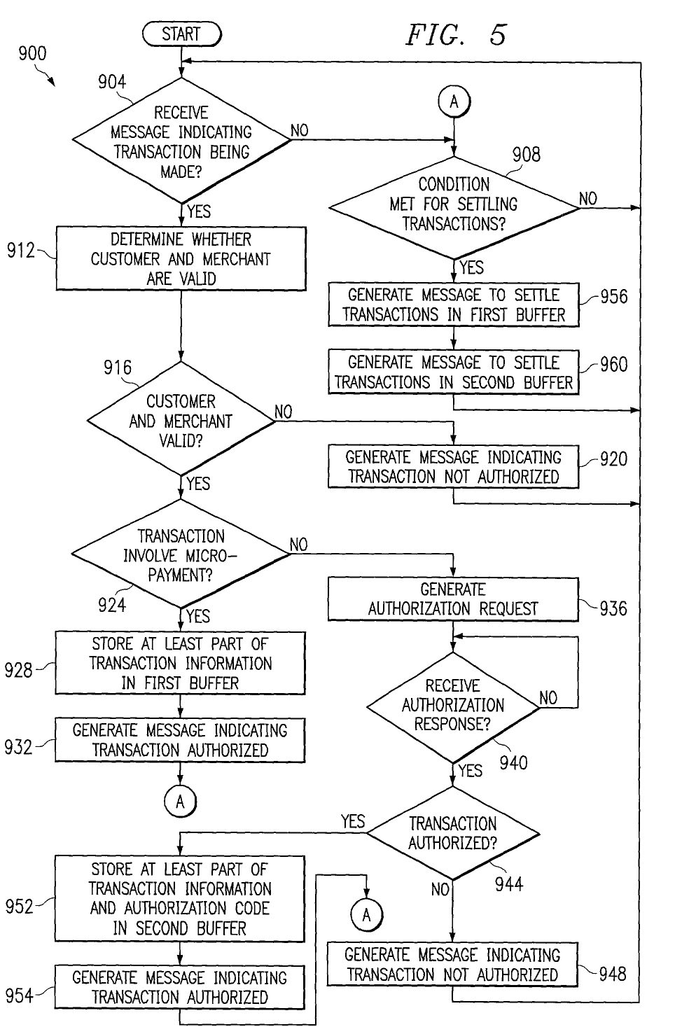

FIG. 5 is a flowchart 900 showing the operation of a transaction controller, such as, for example, transaction controller 40, in accordance with the present invention. The operation begins at decision block 904, where the transaction controller determines whether it has received a message indicating that a financial transaction is being made. If the transaction controller determines that it has not received such a message, it determines whether a condition has been met for settling financial transactions at decision block 908. If no condition has been met for settling financial transactions, the transaction controller returns to decision block 904. The transaction controller will continue to cycle between decision blocks 904 and 908 until it either determines that it has received an appropriate message or an appropriate condition has been met.

Once the transaction controller determines that it has received a message indicating that a financial transaction is being made at decision block 904, transaction controller determines, based on the customer information and the merchant information included in the financial transaction request, whether the customer and the merchant are valid at decision block 916. If the transaction controller determines that one of the customer or the merchant is invalid, it generates an authorization message indicating that the financial transaction is not authorized at function block 920 and returns to decision block 904. If, however, both the customer and the merchant are valid at decision block 916, the transaction controller proceeds to decision block 924, where it decides whether the financial transaction involves a micro-payment. If the financial transaction does involve a micro-payment, the transaction controller stores at least part of the transaction information in a first buffer at function block 928 and generates a message indicating that the financial transaction is authorized at function block 932. Then, the transaction controller proceeds to decision block 908.

On the other hand, if the transaction controller determines that the transaction does not involve a micro-payment at decision block 924, the transaction controller proceeds to generate an authorization request at function block 936. The transaction controller waits to receive an authorization response at decision block 940. Once the transaction controller receives the authorization response, it determines, by examining the authorization response, whether the transaction is authorized at decision block 944. If the transaction is not authorized, the transaction controller generates an authorization message indicating that the financial transaction is not authorized at function block 948 and returns to decision block 904. If, however, the transaction controller determines that the transaction is authorized, it stores at least part of the transaction information and the authorization code in the authorization response in a second buffer at function block 952 and generates a message indicating that the financial transaction is authorized at function block 954. The transaction controller then proceeds to decision block 908.

At decision block 908, as discussed previously, if the transaction controller determines that no condition has been met for settling financial transactions, the transaction controller returns to decision block 904. However, if a condition has been met for settling financial transactions, the transaction controller generates a message to settle the financial transactions represented by the information stored in the first buffer at function block 956. The transaction controller also generates a message to settle the financial transactions represented by the information stored in the second buffer at function block 960. The transaction controller then returns to decision block 904.

Although a variety of operations have been illustrated by flowchart 900, a transaction controller in accordance with the present invention may have only some of the operations illustrated by flowchart 900 and/or additional operations. Additionally, although an ordering of operations has been illustrated by flowchart 900, a transaction controller in accordance with the present invention may have a different ordering of the operations. For example, the transaction controller may not determine whether the merchant is valid. This could happen when, for example, transaction controller 40 is part of merchant 30; thus, there might be no need for transaction controller 40 to validate merchant 30. As another example, the transaction controller does not have to use certificates to validate the customer, because it could use other validation schemes, such as, for example, an account identifier plus a password or a biometric. As an additional example, the transaction controller may store all of the transaction information needed to settle all of the financial transactions of a merchant in a single buffer. This could happen when, for example, transaction controller computer 400 assigns an authorization code to the financial transactions that involve micro-payments. As a further example, the transaction controller may decide whether a financial transaction involves a micro-payment before determining whether the customer and merchant are valid and, if the financial transaction does not involve a micro-payment, generate an authorization request without determining whether the customer and merchant are valid. Note, the merchant would still be protected because the customer financial institution would authorize the financial transaction. A variety of other operations and/or ordering of operations will be readily suggested to those skilled in the art.

Although the invention has been discussed mainly with respect to customer purchases over the Internet, an embodiment of which is shown in FIG. 2, the invention is also applicable to other types of purchases. For example, the invention is applicable to purchases that occur in traditional stores by means of a credit card, debit card, or other similar financial transaction mechanism, because the merchant still needs to obtain an authorization for the transaction. Of course, as opposed to FIG. 2, there would probably be no customer computer 200 and catalog 310, but the other components of system 10 could exist. But there could be a certificate like certificate 210—stored electronically on a token, such as, for example, on a chip located on a card, on a magnetic strip, or on any other suitable storage media—that could be used to validate the customer. As another example, the invention is applicable to conventional catalog retailers. Of course, as opposed to FIG. 2, the information in catalog 310 is probably in printed form and customer 20 communicates with a human employed by merchant 30 by telephone. However, merchant 30 may still validate customer 20 by using the account identifier and/or any other suitable criteria. Other varieties of transactions exist.

Furthermore, although the invention has been discussed mainly with respect to processing credit card transactions, the invention is applicable to other financial transactions. For example, debit cards typically require authorization similar to that of credit cards. In addition, checks often require authorization. In general then, the invention is applicable to financial transactions that require some type of authorization.

Although several embodiments of the present invention have been discussed, numerous additions, deletions, substitutions, and/or alterations to the invention may be readily suggested to one of skill in the art without departing from the scope of the appended claims. It is intended therefore that the appended claims encompass such additions, deletions, substitutions, and/or alterations.

What is claimed is:

1. An apparatus for processing financial transactions, comprising:
a memory operable to store information and a program, the memory further operable to store a first message indicating the making of a financial transaction, the first message including customer information and transaction information; and
a processor coupled to the memory, the processor, according to the program, operable to:
determine the validity of the customer information,
generate a second message indicating non-authorization of the financial transaction if the customer information is invalid,
determine whether the financial transaction involves a micro-payment if the customer information is valid,
instruct the memory to store at least part of the transaction information and generate a third message indicating authorization of the financial transaction if the financial transaction involves a micro-payment, and
generate an authorization request if the financial transaction does not involve a micro-payment.

2. The apparatus of claim 1, further comprising a communication interface adapted to be coupled to a communication link and coupled to the memory, the communication interface operable to receive information from and send information over the communication link.

3. The apparatus of claim 2, wherein the communication interface is a network interface card.

4. The apparatus of claim 1, wherein:
the customer information comprises a digital certificate; and
the transaction information comprises the time of initiation of the financial transaction, the amount of the financial transaction, and a customer account identifier.

5. The apparatus of claim 4, wherein the customer account identifier represents a credit card account.

6. The apparatus of claim 4, wherein the digital certificate complies with X.509.

7. The apparatus of claim 1, wherein the memory comprises random access memory.

8. The apparatus of claim 1, wherein the processor is further operable to determine whether the customer information is in an appropriate format and is associated with an account that is in good standing to determine the validity of the customer information.

9. The apparatus of claim 1, wherein the processor is further operable to generate a validation request based on the customer information, receive a validation response indicating the validity of the customer information, and analyze the validation response to determine the validity of the customer information.

10. The apparatus of claim 1, wherein the processor is further operable to determine whether the amount of the financial transaction is below a threshold to determine whether the financial transaction involves a micro-payment.

11. The apparatus of claim 1, wherein the processor is further operable to instruct the memory to store the time of initiation of the financial transaction, the amount of the financial transaction, and a customer account identifier to instruct the memory to store at least part of the transaction information.

12. The apparatus of claim 1, wherein the processor is further operable to instruct the memory to store, in a buffer, at least part of the transaction information for each of a plurality of financial transactions that involves a micro-payment.

13. The apparatus of claim 1, wherein the processor is further operable to generate a fourth message to settle the financial transaction based on the stored part of the transaction information.

14. The apparatus of claim 13, wherein the processor generates the fourth message at a designated time.

15. The apparatus of claim 1, wherein:
the first message includes merchant information; and
the processor is further operable to determine whether the merchant information is valid, generate the second message if the merchant information is invalid, and determine whether the financial transaction involves a micro-payment only if the merchant information is valid.

16. The apparatus of claim 15, wherein the merchant information comprises a digital certificate.

17. The apparatus of claim 15, wherein the processor is further operable to instruct the memory to store, in a buffer, at least part of the transaction information for each of a plurality of financial transactions that involves a micro-payment and is associated with the merchant information.

18. The apparatus of claim 17, wherein the processor is further operable to generate a fifth message to settle all of the financial transactions based on the part of the transaction information stored for each financial transaction in the buffer.

19. A method for processing financial transactions, comprising:
receiving a first message indicating the making of a financial transaction, the first message including customer information and transaction information;
determining the validity of the customer information;
generating a second message indicating non-authorization of the financial transaction if the customer information is invalid;
determining whether the financial transaction involves a micro-payment if the customer information is valid;
if the financial transaction involves a micro-payment:
storing at least part of the transaction information, and
generating a third message indicating authorization of the financial transaction; and
if the financial transaction does not involve a micro-payment, generating an authorization request.

20. The method of claim 19, wherein receiving a first message including transaction information comprises receiving the time of initiation of the financial transaction, the amount of the financial transaction, and a customer account identifier.

21. The method of claim 20, wherein the customer account identifier represents a credit card account.

22. The method of claim 19, wherein:
the customer information comprises a digital certificate; and
determining the validity of the customer information comprises determining the validity of the digital certificate.

23. The method of claim 19, wherein determining the validity of the customer information comprises generating a validation request based on the customer information, receiving a validation response indicating the validity of the customer information, and analyzing the validation response.

24. The method of claim 19, wherein determining whether the financial transaction involves a micro-payment comprises determining whether the amount of the financial transaction is below a threshold.

25. The method of claim 19, wherein storing at least part of the transaction information comprises storing the time of initiation of the financial transaction, the amount of the financial transaction, and a customer account identifier.

26. The method of claim 19, further comprising storing at least part of the transaction information for each of a plurality of financial transactions that involves a micro-payment.

27. The method of claim 19, further comprising generating a fourth message to settle the financial transaction based on the stored part of the transaction information.

28. The method of claim 27, wherein generating a fourth message to settle the financial transaction comprises generating the fourth message at a designated time.

29. The method of claim 19, wherein the first message includes merchant information, and further comprising:
determining the validity of the merchant information;
generating the second message if the merchant information is invalid; and
determining whether the financial transaction involves a micro-payment only if the merchant information is valid.

30. The method of claim 29, wherein the merchant information comprises a digital certificate.

31. The method of claim 29, further comprising storing, in a buffer, at least part of the transaction information for each of a plurality of financial transactions that involves a micro-payment and is associated with the merchant information.

32. The method of claim 31, further comprising generating a fifth message to settle all of the financial transactions based on the part of the transaction information stored for each financial transaction in the buffer.

33. A set of logic encoded in media for processing financial transactions, the logic operable to perform the following operations:
detect the reception of a first message indicating the making of a financial transaction, the first message including customer information and transaction information;
determine the validity of the customer information;
generate a second message indicating non-authorization of the financial transaction if the customer information is invalid;
determine whether the financial transaction involves a micro-payment if the customer information is valid;
if the financial transaction involves a micro-payment:
instruct a memory to store at least part of the transaction information, and
generate a third message indicating authorization of the financial transaction; and
if the financial transaction does not involve a micro-payment, generate an authorization request.

34. The logic of claim 33, wherein the transaction information includes the time of initiation of the financial transaction, the amount of the financial transaction, and a customer account identifier.

35. The logic of claim 34, wherein the customer account identifier represents a credit card account.

36. The logic of claim 33, wherein:
the customer information comprises a digital certificate; and
the logic is further operable to determine the validity of the digital certificate to determine the validity of the customer information.

37. The logic of claim 33, wherein the logic is further operable to generate a validation request based on the customer information, receive a validation response indicating the validity of the customer information, and analyze the validation response to determine the validity of the customer information.

38. The logic of claim 33, wherein the logic is further operable to determine whether the amount of the financial transaction is below a threshold to determine whether the financial transaction involves a micro-payment.

39. The logic of claim 33, wherein the logic is further operable to instruct the memory to store the time of initiation of the financial transaction, the amount of the financial transaction, and a customer account identifier to instruct a memory to store at least part of the transaction information.

40. The logic of claim 33, wherein the logic is further operable to instruct the memory to store at least part of the transaction information for each of a plurality of financial transactions that involves a micro-payment.

41. The logic of claim 33, wherein the logic is further operable to generate a fourth message to settle the financial transaction based on the stored part of the transaction information.

42. The logic of claim 41, wherein the logic is further operable to generate the fourth message at a designated time.

43. The logic of claim 33, wherein the first message includes merchant information, and the logic is further operable to:
determine the validity of the merchant information;
generate the second message if the merchant information is invalid; and
determine whether the financial transaction involves a micro-payment only if the merchant information is valid.

44. The logic of claim 43, wherein the merchant information comprises a digital certificate.

45. The logic of claim 43, wherein the logic is further operable to instruct the memory to store, in a buffer, at least part of the transaction information for each of a plurality of financial transactions that involves a micro-payment and is associated with the merchant information.

46. The logic of claim 45, wherein the logic is further operable to generate a fifth message to settle all of the financial transactions based on the part of the transaction information stored for each financial transaction in the buffer.

47. The logic of claim 33, wherein the media is random access memory.

48. An apparatus for processing financial transactions, comprising:
a communication interface adapted to be coupled to a communication link, the communication interface operable to receive information from and send information over the communication link, the communication interface further operable to receive a first message indicating the making of a financial transaction, the first message including customer information, merchant information, and transaction information;
a memory coupled to the communication interface, the memory operable to store information and a program;
a processor coupled to the memory, the processor, according to the program, operable to:
generate a validation request based on the customer information and the merchant information,
receive a validation response indicating the validity of the customer information and the merchant information,
generate a second message indicating non-authorization of the financial transaction if either the customer information or the merchant information is invalid,
determine, if both the customer information and the merchant information are valid, whether the financial transaction involves a micro-payment by analyzing whether the amount of the financial transaction is below a threshold,
if the financial transaction involves a micro-payment, instruct the memory to store at least part of the transaction information in a buffer and generate a third message indicating authorization of the financial transaction,
if the financial transaction does not involve a micro-payment, generate an authorization request, receive an authorization response, and generate a fourth message indicating the authorization status of the financial transaction, and
generate a fifth message to settle the financial transaction based on the part of the transaction information stored in the buffer.

49. The apparatus of claim 48, wherein the communication interface is a network interface card.

50. The apparatus of claim 48, wherein:
the customer information comprises a digital certificate;
the merchant information comprises a digital certificate; and
the transaction information comprises the time of initiation of the financial transaction, the amount of the financial transaction, and a customer account identifier.

51. The apparatus of claim 48, wherein the memory comprises random access memory.

52. The apparatus of claim 48, wherein the processor is further operable to instruct the memory to store the time of initiation of the financial transaction, the amount of the financial transaction, and a customer account identifier in the buffer to instruct the memory to store at least part of the transaction information in a buffer.

53. The apparatus of claim 48, wherein the processor is further operable to instruct the memory to store at least part of the transaction information for each of a plurality of financial transactions that involves a micro-payment in the buffer.

54. The apparatus of claim 48, wherein the processor generates the fifth message at a designated time.
